(19) United States
(12) Patent Application Publication
(10) Pub. No.: US 2026/0368906 A1
(43) Pub. Date: Nov. 19, 2026

(54) SYSTEM AND METHOD FOR DETECTING OBJECT BY UTILIZING SEGMENTATION OF AUTONOMOUS DRIVING SENSOR

(71) Applicants: Hyundai Motor Company, Seoul (KR); Kia Corporation, Seoul (KR)

(72) Inventor: Nam Gyun KIM, Hwaseong-Si (KR)

(21) Appl. No.: 19/380,481

(22) Filed: Nov. 5, 2025

(30) Foreign Application Priority Data
May 15, 2025 (KR) 10-2025-0063526

(51) Int. Cl. G06T 7/20; B60W 60/00; G06T 7/10; G06V 10/25; G06V 10/77

(52) U.S. Cl. CPC G06T 7/20; B60W 60/001; G06T 7/10; G06V 10/25; G06V 10/7715; G06V 2201/07

(57) ABSTRACT

Disclosed are an apparatus and a method for recognizing an object by using segmentation of an autonomous driving sensor. The apparatus may: receive, from a sensor of the vehicle, a plurality of point data corresponding to an object in a surrounding environment of the vehicle; perform multi-class segmentation on the plurality of point data; recognize, based on the plurality of point data, a point that corresponds to a ground; perform a first fusing operation on a result of the multi-class segmentation and a result of recognizing the point that corresponds to the ground; perform a second fusing operation on a cuboid box for the object and an outline of the object; extract a feature point and odometry for the surrounding environment; track, based on a result of the second fusing operation, the object; and control an autonomous driving operation of the vehicle.

### CROSS-REFERENCE TO RELATED APPLICATION

This application claims the benefit of priority to Korean Patent Application No. 10-2025-0063526, filed in the Korean Intellectual Property Office on May 15, 2025, the entire contents of which are incorporated herein by reference.

### TECHNICAL FIELD

The present disclosure relates to autonomous vehicles, and more specifically to a system and a method for object recognition in autonomous vehicles.

### BACKGROUND

As autonomous vehicles are developed and commercialized, various sensors and artificial intelligence (AI) technologies are being adopted to support the autonomous driving functions of vehicles. For example, active research is being done on recognizing various objects in front of a moving vehicle, what the distance is between each of the objects and the vehicle, and what algorithms the vehicle should use to respond to specific situations to ensure safety.

Accordingly, vehicle sensor technology has been advancing, and high-performance sensors are being installed on vehicles, such as a light detection and ranging (lidar) sensor that recognizes the surrounding environment of the vehicle using laser beams, a radar sensor that uses radio waves, a ultrasonic sensor, a fisheye camera capable of photographing 360-degree images, a multifocal lens, a global positioning systems (GPS), and more.

By aggregating measurement results obtained from multiple sensors (e.g., multiple different types of sensors) as described above, it has become possible to implement a so-called super sensor vehicle. In autonomous driving (or self-driving), the concept of a super sensor refers to a technology that aims to recognize the surrounding environment more accurately by combining measurements from various disparate sensors rather than relying on individual sensors separately for the convenience and safety of driving. With the advent of information and communications technology (ICT) and cloud technology, the sensors required for autonomous driving and the AI algorithms related to them have become more sophisticated than ever before, not only targeting a single vehicle, but also remotely accumulating data from numerous vehicle units (e.g., a fleet of vehicles) and training AI servers and databases to increase the confidence of vehicle sensor determination.

The matters described in this Background section are only for enhancement of understanding of the background of the disclosure, and should not be taken as acknowledgement that they correspond to prior art already known to those skilled in the art.

### SUMMARY

The present disclosure has been made to solve some of the problems occurring in at least some implementations while advantages achieved by those implementations are maintained intact.

An aspect of the present disclosure provides a system and a method for recognizing a surrounding environment and an object of an autonomously driving vehicle based on an autonomous driving sensor, and more specifically, provides a system and a method capable of improving the recognition technology for an object, a surrounding environment and calculation on the movement amount of a host vehicle (equipped with an autonomous driving sensor) by utilizing LiDAR segmentation as a main technical task.

The technical problems to be solved by the present disclosure are not limited to the aforementioned problems, and any other technical problems not mentioned herein will be clearly understood from the following description by those skilled in the art to which the present disclosure pertains.

In order to solve all or at least part of the technical problems described above, one or more embodiments of the present disclosure may be implemented in various aspects as follows.

According to one or more example embodiments of the present disclosure, an apparatus of a vehicle may include a processor and a memory. The memory may store at least one instruction that is configured, when executed by the processor, to cause the apparatus to: receive, from a sensor of the vehicle, a plurality of point data corresponding to an object in a surrounding environment of the vehicle; store, in the memory, the plurality of point data; detect, based on the plurality of point data, the object; perform multi-class segmentation on the plurality of point data; recognize, based on the plurality of point data, a point that corresponds to a ground; perform a first fusing operation on a result of the multi-class segmentation and a result of recognizing the point that corresponds to the ground; perform a second fusing operation on a cuboid box for the object and an outline of the object; extract, based on a result of the first fusing operation, a feature point and odometry for the surrounding environment; track, based on a result of the second fusing operation, the object; track, based on the feature point and the odometry, the surrounding environment; and control, based on the tracking of the object and the tracking of the surrounding environment, an autonomous driving operation of the vehicle.

The at least one instruction may be configured, when executed by the processor, to cause the apparatus to perform the second fusing operation by: combining and processing a result of fusing the cuboid box and the outline of the object.

The at least one instruction may be configured, when executed by the processor, to cause the apparatus to combine and process the result of fusing the cuboid box and the outline of the object based on at least one of: an occupancy model, a road model, a scene understanding model, or the odometry.

The at least one instruction may be configured, when executed by the processor, to cause the apparatus to extract the feature point and the odometry by: combining and processing results of measuring the surrounding environment and the odometry.

The at least one instruction may be configured, when executed by the processor, to cause the apparatus to combine and process the results of measuring the surrounding environment and the odometry based on at least one of: an occupancy model, a road model, a scene understanding model, or the odometry.

The at least one instruction may be configured, when executed by the processor, to further cause the apparatus to: correct, during driving of the vehicle and based on a result of continuously estimating the odometry, a misalignment of the sensor.

The at least one instruction may be configured, when executed by the processor, to cause the apparatus to perform the first fusing operation by: determining a final class based on: the result of recognizing the point that corresponds to the ground, based on a region of interest condition being satisfied or a network confidence condition not being satisfied; or the result of the multi-class segmentation, based on the region of interest condition not being satisfied and the network confidence condition being satisfied.

The at least one instruction may be configured, when executed by the processor, to cause the apparatus to perform the second fusing operation by one of: registering the cuboid box in a valid box list based on a region of interest condition being satisfied or a network confidence condition not being satisfied, or registering the object detection result in the valid box list based on the region of interest condition not being satisfied and the network confidence condition being satisfied.

The at least one instruction may be configured, when executed by the processor with the memory, to cause the apparatus to perform the second fusing operation further by: before determining the region of interest condition, associating a result of the detecting of the object with the cuboid box based on an intersection over union of the result of the detecting of the object and the cuboid box.

The at least one instruction may be configured, when executed by the processor with the memory, to cause the apparatus to perform the second fusing operation by: based on determining that the object has an irregular shape, tagging the object and registering the object in the valid box list. The at least one instruction may be configured, when executed by the processor with the memory, to cause the apparatus to track the object further based on the multi-class segmentation.

According to one or more example embodiments of the present disclosure, a method performed by an apparatus of a vehicle may include: receiving, from a sensor of the vehicle, a plurality of point data corresponding to an object in a surrounding environment of the vehicle; detecting, based on the plurality of point data, the object; performing multi-class segmentation on the plurality of point data; recognizing, based on the plurality of point data, a point that corresponds to a ground; performing a first fusing operation on a result of the multi-class segmentation and a result of recognizing the point that corresponds to the ground; performing a second fusing operation on a cuboid box for the object and an outline of the object; extracting, based on a result of the first fusing operation, a feature point and odometry for the surrounding environment; tracking, based on a result of the second fusing operation, the object; tracking, based on the feature point and the odometry, the surrounding environment; and controlling, based on the tracking of the object and the tracking of the surrounding environment, an autonomous driving operation of the vehicle.

The second fusing operation may include: combining and processing a result of fusing the cuboid box and the outline of the object.

The combining and processing process may be based on at least one of: an occupancy model, a road model, a scene understanding model, or the odometry.

Extracting the feature point and the odometry may include: combining and processing results of measuring the surrounding environment and the odometry.

The combining and processing may be based on at least one of: an occupancy model, a road model, a scene understanding model, or the odometry.

The method may further include: correcting, during driving of the vehicle and based on a result of continuously estimating the odometry, a misalignment of the sensor.

The first fusing operation may include: determining a final class based on: the result of recognizing the point that corresponds to the ground, based on a region of interest condition being satisfied or a network confidence condition not being satisfied; or the result of the multi-class segmentation, based on the region of interest condition not being satisfied and the network confidence condition being satisfied.

The second fusing operation may include: registering the cuboid box in a valid box list based on a region of interest condition being satisfied or a network confidence condition not being satisfied, or registering the object detection result in the valid box list based on the region of interest condition not being satisfied and the network confidence condition being satisfied.

The second fusing operation may include: before determining the region of interest condition, associating a result of the detecting of the object with the cuboid box based on an intersection over union of the result of the detecting of the object and the cuboid box.

The second fusing operation may include: based on determining that the object has an irregular shape, tagging the object and registering the object in the valid box list. Tracking the object may be further based on the multi-class segmentation.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example system for automatically recognizing an object and controlling autonomous driving operations of a vehicle;

FIG. 2 is a flowchart illustrating an example algorithm for an object recognition architecture utilizing LiDAR segmentation;

FIG. 3 is a flowchart illustrating an example algorithm regarding a segment fusion process of an object recognition architecture utilizing LiDAR segmentation;

FIG. 4 is a flowchart illustrating an example algorithm regarding an object fusion process of an object recognition architecture utilizing LiDAR segmentation;

FIG. 5 is a flowchart illustrating an example algorithm for an object measurement refinement (or processing) process of an object recognition architecture utilizing LiDAR segmentation;

FIG. 6 is a flowchart illustrating an example algorithm for a refinement (or processing) process related to the surrounding environment measurement of an object recognition architecture utilizing LiDAR segmentation; and

FIG. 7 is a block diagram illustrating an example computing system for controlling an autonomous vehicle and operating object recognition.

### DETAILED DESCRIPTION

Hereinafter, one or more example embodiments of the present disclosure will be described in detail with reference to the example drawings. In adding the reference numerals to the components of each drawing, it should be noted that the identical or equivalent component is specified by the identical numeral even when they are displayed on other drawings. Further, in describing the example embodiment(s) of the present disclosure, a detailed description of the related known configuration or function will be omitted when it is determined that it interferes with the understanding of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure. For example, in the present disclosure, an object has virtually the same meaning as an object, and the expressions “object” and “subject” are arbitrarily used interchangeably in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., multi-class segmentation of sensor data) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., multi-class segmentation of sensor data) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., multi-class segmentation of sensor data) described herein.

Minimum risk maneuver (MRM) operation(s) may also be controlled, for example, based on one or more features (e.g., multi-class segmentation of sensor data) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., multi-class segmentation of sensor data) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may include an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., multi-class segmentation of sensor data) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., multi-class segmentation of sensor data) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., multi-class segmentation of sensor data) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

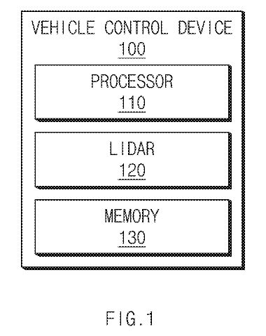

FIG. 1 is a block diagram illustrating an example system for automatically recognizing an object and controlling autonomous driving operations of a vehicle.

Referring to FIG. 1, a vehicle control device 100 may be implemented inside or outside a vehicle, and some of the components included in the vehicle control device 100 may be implemented inside or outside the vehicle. In this case, the vehicle control device 100 may be formed integrally with the internal control units of the vehicle, or may be implemented as a separate device and connected to the control units of the vehicle by a separate connection means. For example, the vehicle control device 100 may further include components not shown in FIG. 1.

The vehicle control device 100 may include a processor 110, a light detection and ranging (LiDAR) 120, and a memory 130. The processor 110, the lidar 120, or the memory 130 may be electronically and/or operably coupled with each other by an electronic component including a communication bus.

Hereinafter, hardware being operably coupled may mean that a direct connection or an indirect connection between the hardware is established wired or wirelessly, such that second hardware is controlled by first hardware among the hardware.

Although illustrated in different blocks, the present disclosure is not limited thereto, and some of the hardware in FIG. 1 may be included in a single integrated circuit such as a system on chip (SoC). The type and/or number of hardware included in the vehicle control device 100 is not limited to that illustrated in FIG. 1. For example, the vehicle control device 100 may include only some of the hardware illustrated in FIG. 1.

The vehicle control device 100 may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), a graphic processing unit (GPU), and/or an application processor (AP). The processor 110 may have a single-core processor structure, or may have the structure of a multi-core processor including dual cores, quad cores, hexa cores, or octa cores.

The processor 110 may include at least one of a graphic processing unit (GPU), a neural processing unit (NPU), or any combination thereof. For example, a GPU may be referred to as a visual processing unit (VPU). For example, an NPU may be referred to as a neural network processing unit.

The vehicle control device 100 may include a depth sensor for detecting an external object. For example, a depth sensor for detecting an external object may include at least one of a time-of-flight (ToF) sensor, the lidar 120, a structured light sensor, an ultrasonic sensor, an infrared sensor, a radio detection and ranging (radar), an optical distance sensor, or any combination thereof. Hereinafter, for convenience of explanation, the description will focus on the lidar.

The vehicle control device 100 may include the lidar 120 that obtains a plurality of points based on a pulse laser signal. The plurality of points may be, for example, a plurality of point data (data points) or a point cloud. For example, the lidar 120 may obtain data sets that identify objects surrounding the vehicle control device 100 (or a vehicle including the vehicle control device 100). For example, the lidar 120 may identify at least one of the position, direction of movement, speed, or any combination thereof of surrounding objects based on the pulse laser signal emitted from the lidar 120 being reflected back from surrounding objects.

For example, the lidar 120 may obtain data sets representing external objects in the space formed by the x-axis, the y-axis, and the z-axis based on pulse laser signals reflected from surrounding objects. For example, the lidar 120 may obtain data sets including a plurality of points in the space formed by the x-axis, the y-axis, and the z-axis based on receiving a pulse laser signal every specified time period. For example, the plurality of points may include points representing external objects within a three-dimensional virtual coordinate system. The three-dimensional (3D) virtual coordinate system may include at least one of a vehicle coordinate system, a lidar coordinate system, or any combination thereof. However, examples of the 3D virtual coordinate system are not limited to those described above.

The memory 130 of the vehicle control device 100 may include a hardware component for storing data and/or instructions input and/or output to the processor 110. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof.

In the memory 130 of the vehicle control device 100, one or more instructions (or commands) indicating calculation and/or operations to be performed by the processor 110 of the vehicle control device 100 with data may be stored. A set of one or more instructions may be referred to as a program, firmware, an operating system, a process, a routine, a sub-routine, and/or an application.

Hereinafter, the fact that an application is installed in the vehicle control device 100 may mean that one or more instructions provided in the form of an application are stored in the memory 130, and that one or more applications are stored in a format executable by the processor 110 of the vehicle control device 100 (e.g., a file having an extension specified by an operating system of the vehicle control device 100).

For example, the memory 130 may include a first neural network model for detecting an object. For example, the memory 130 may include a second neural network model for outputting the types of the plurality of points obtained by the lidar 120 and/or the scores of the plurality of points.

The processor 110 may obtain at least one of a first virtual box representing a target object, a first class representing a type of the target object, or a combination thereof, based on the plurality of points obtained through the lidar 120 and the first neural network model stored in the memory 130.

For example, the processor 110 may obtain at least one of a first virtual box representing a target object, a first class representing a type of the target object, or any combination thereof, based on inputting the plurality of points into the first neural network model. For example, the first neural network model may include an object detection model. For example, the target object may include an external object located within a specified distance from the vehicle control device 100 (or a host vehicle including the vehicle control device 100). For example, the target object may include an object that is identified by the vehicle control device 100 and is continuously tracked. For example, the type of a target object may include multiple types for classifying the target object. For example, the type of the target object may include at least one of a first type representing the ground, a second type representing a type different from the ground, or any combination thereof. However, the type of a target object is not limited to the above. For example, the type of a target object may include, at least one of a third type representing a person, a fourth type representing a vehicle, or any combination thereof, but is not limited thereto.

The processor 110 may obtain, based on the plurality of points and the second neural network model, at least one of first partial points corresponding to at least a part of the target object among the plurality of points, a second class identified through the first partial points and indicating the type of the target object, or any combination thereof. For example, the second neural network model may include a segmentation model.

For example, the second neural network model may include a neural network model for obtaining types of the plurality of points and scores of the plurality of points.

For example, the processor 110 may obtain first partial points corresponding to at least a portion of the target object among the plurality of points based on inputting the plurality of points into the second neural network model. For example, the processor 110 may identify the types of the plurality of points based on inputting the plurality of points into the second neural network model. For example, the processor 110 may obtain the first partial points corresponding to at least a portion of the target object from among the plurality of points based on the type of each of the plurality of points.

The processor 110 may perform a first specified algorithm for a plurality of points. For example, the processor 110 may perform the first specified algorithm for classifying a type of each of the plurality of points for a plurality of points. For example, the processor 110 may classify second partial points corresponding to a specified type among the plurality of points. For example, the specified type may include a type representing the ground.

For example, the processor 110 may classify the second partial points corresponding to a specified type based on performing the first specified algorithm on the plurality of points, and obtain (or identify) the first partial points by excluding the second partial points from among the plurality of points.

The processor 110 may obtain at least one of a partial class for obtaining a second class, a score of each of the plurality of points, or any combination thereof, based on inputting the plurality of points into the second neural network model. For example, the processor 110 may obtain a partial class and a score for each of the plurality of points based on inputting the plurality of points into the second neural network model. For example, the partial class may include a classification of each of the plurality of points into an arbitrary type.

For example, the processor 110 may fuse the partial class, the score of each of the plurality of points, and the second partial points. For example, the processor 110 may perform clustering based on the fusion of the partial class, the score of each of the plurality of points, and the second partial points. For example, clustering may include grouping the first partial points that correspond to at least part of a target object.

For example, the processor 110 may obtain a point cloud for generating a second virtual box based on the first partial points. For example, the processor 110 may obtain the point cloud based on grouping the first partial points.

For example, the processor 110 may generate a second virtual box for representing the target object, which is different from the first virtual box, based on the point cloud. For example, the second virtual box may include a box that includes at least some of the first partial points.

For example, the processor 110 may identify a heading direction indicating the moving direction of the target object based on at least one of the first partial points, the point cloud, or any combination thereof.

For example, the processor 110 may identify the position of the second virtual box in a virtual coordinate system based on at least one of the first partial points, the point cloud, or any combination thereof. For example, the processor 110 may identify the size of the second virtual box based on at least one of the first partial points, the point cloud, or any combination thereof. For example, the processor 110 may identify the second class based on at least one of the first partial points, the point cloud, or any combination thereof. For example, the processor 110 may identify at least one of the heading direction indicating the moving direction of a target object, the position of the second virtual box in the virtual coordinate system, the size of the second virtual box, the second class, or any combination thereof, based on at least one of the first partial points, the point cloud, or any combination thereof. For example, the processor 110 may identify the heading direction of the bounding box based on at least one of the first virtual box, the first class, the heading direction of the second virtual box, the position of the second virtual box, the size of the second virtual box, the second class, or any combination thereof. For example, the processor 110 may identify the position of the bounding box in the virtual coordinate system based on at least one of the first virtual box, the first class, the heading direction of the second virtual box, the position of the second virtual box, the size of the second virtual box, the second class, or any combination thereof. For example, the processor 110 may obtain a third class indicating the type of a target object corresponding to the bounding box based on at least one of the first virtual box, the first class, the heading direction of the second virtual box, the position of the second virtual box, the size of the second virtual box, the second class, or any combination thereof. For example, the processor 110 may obtain at least one of the heading direction of the bounding box, the position of the bounding box in the virtual coordinate system, the third class indicating the type of a target object corresponding to the bounding box, or any combination thereof, based on at least one of the first virtual box, the first class, the heading direction of the second virtual box, the position of the second virtual box, the size of the second virtual box, the second class, or any combination thereof.

For example, the processor 110 may assign a first identifier for tracking the second virtual box to the second virtual box. For example, the processor 110 may assign a second identifier corresponding to the first identifier to the bounding box.

For example, the processor 110 may track the bounding box by using the second identifier. For example, the processor 110 may track a target object based on identifying a plurality of bounding boxes including the bounding box to which the second identifier is assigned, in a plurality of frames. For example, because the second identifier is an identifier assigned to the bounding box corresponding to the target object, the processor 110 may track the target object by identifying the plurality of bounding boxes to which the second identifier is assigned, in the plurality of frames.

The processor 110 may output the bounding box corresponding to the target object based on at least one of the first virtual box, the first class, the first partial points, the second class, or any combination thereof. For example, the bounding box may include an example of a target object represented in the virtual coordinate system in the form of a hexahedron.

Hereinafter, operations performed by a CPU, a GPU, and/or an NPU included in the processor 110 will be briefly described.

The processor 110 may include at least one of a CPU, a GPU, an NPU, or any combination thereof. For example, at least one of the GPU, the NPU, or any combination thereof may obtain the first virtual box and the first class based on the first neural network model. For example, at least one of the GPU and the NPU may obtain the first virtual box and the first class. For example, at least one of the GPU, the NPU, or any combination thereof may obtain the partial class for obtaining the second class and the score for each of the plurality of points based on the second neural network model. For example, at least one of the GPU and the NPU may obtain the partial class for obtaining the second class and the score for each of the plurality of points based on the second neural network model. For example, the CPU may classify second partial points among the plurality of points that correspond to a specified type, based on performing the first specified algorithm for classifying the type of each of the plurality of points for the plurality of points.

As described above, the vehicle control device 100 may include at least one processor 110. The vehicle control device 100 may accurately detect a target object by detecting the target object using at least one processor 110. In addition, by performing parallel processes, the vehicle control device 100 may reduce the load on each processor.

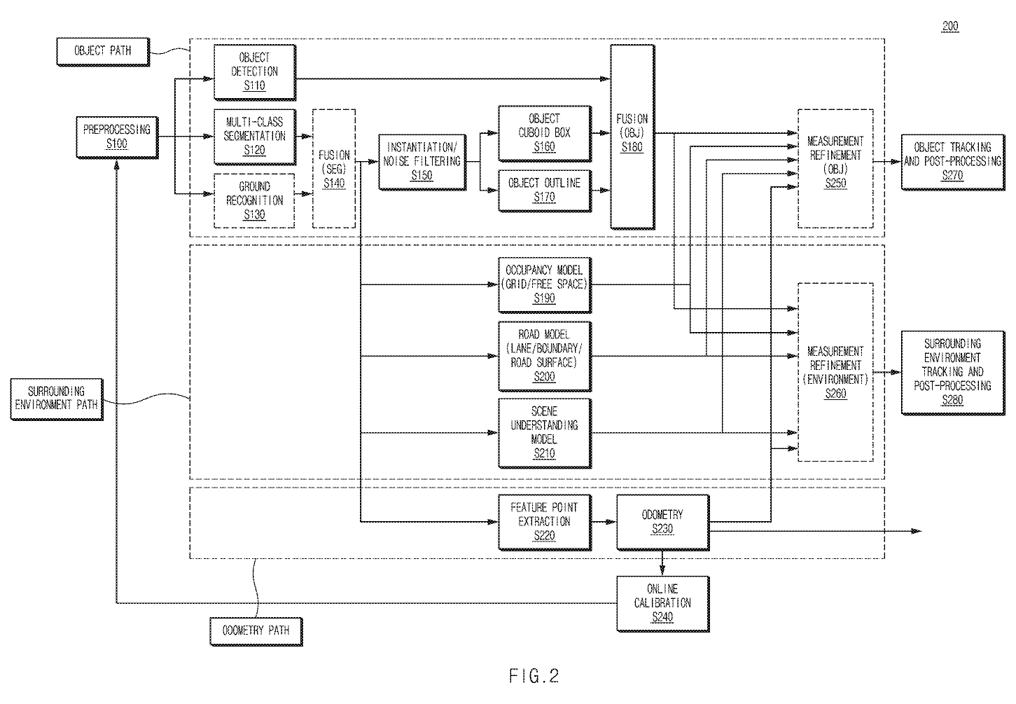

Before describing FIG. 2, for a general understanding of AI object recognition according to the present disclosure, a description related to LiDAR-based object recognition is added as follows.

The object recognition process by LiDAR 120 and AI module includes three operations: preprocessing, segmentation, and tracking.

An object recognition system 1000 according to the present disclosure performs a preprocessing process before executing an object recognition function. The preprocessing may include, for example, an operation of removing points forming the ground based on laser sensing data (e.g., unprocessed raw data) input from LiDAR 120. Because the laser beam reflected from the ground may be mistakenly recognized as an object on the ground, the process of distinguishing between the ground and non-ground is performed in a preprocessing operation, and when necessary, may also be performed in a segmentation operation.

In short, preprocessing in AI object recognition may be understood as a process in which an image processing tool of an AI module in the processor 110 removes noise from a LiDAR point cloud image and reduces the total number of points existing in the LiDAR point cloud image through, for example, a voxel down-sampling technique to improve computational efficiency.

For reference, the LiDAR point cloud image may also be displayed in a bird’s eye view (BEV) manner. When a LiDAR map is created as if it were a bird’s eye view of the city while flying in the sky, it is called a BEV image.

That is, as described above, the LiDAR 120 transmits a laser beam into a surrounding environment and records the time when the laser beam is reflected by an external object and returns, thereby generating a dot (i.e., a point) for each of numerous laser signals and calculating the distance to the point. By repeatedly transmitting a large number of laser beams in such a manner, the processor 110 may generate a real-time LiDAR map of the surrounding environment as a BEV type three-dimensional map, and as a two-dimensional map when necessary.

The lines or surfaces that appear in black and white on the LiDAR point cloud map are actually composed of countless points (each of which is generated by a laser beam of the LiDAR 120), and for this reason, the LiDAR sensing image is also called a LiDAR point cloud image. For example, by combining a red-green-blue-depth (RGB-D) sensor with a LiDAR sensor, the LiDAR point cloud image may be reconstructed in color.

Although it may be difficult for humans to recognize objects with just one point in a LiDAR point cloud image, when the point cloud is taken into consideration comprehensively, such as from a BEV perspective or a two-dimensional plan, the surroundings of the vehicle currently being driven autonomously may be estimated. Furthermore, it is possible to recognize, for example, vehicles, buses, pedestrians, street trees, traffic signs, etc. existing in a LiDAR point cloud image. In AI image recognition technology, things or people may be called objects, and each object may be classified into a class that belongs to a group with specific characteristics, such as a vehicle class, a bus class, and the like.

In order to classify objects within a LiDAR point cloud image into car and bus classes, the help of a deep AI neural network is needed. In order to find objects in a LiDAR point cloud image and identify the classes of those objects using an AI neural network, AI training may be performed first.

For example, a dataset called PANDASET^{TM} (source: https://pandaset.org/#data-collection) includes over 48,000 camera images (mostly taken in the Silicon Valley area in the United States) and over 16,000 LiDAR scan images, which are annotated with 28 classes in total, including pedestrians, vehicles, bicycles, construction site signs, traffic signs, and the like.

In addition, a LiDAR point cloud image may be visualized to suit the user's desired options by using a point cloud processing tool such as Open 3D^{TM} (source: https://www.open3d.org/). Because the LiDAR 120 is capable of distance detection, a 3D LiDAR image may be reproduced more realistically, for example, by displaying distant objects in dark blue and nearby objects in light blue during visual processing with Open 3D^{TM}.

In addition, as described above, the original LiDAR image (e.g., raw data) may be preprocessed, for example, by applying a technique called voxel (e.g., a 3D pixel) down-sampling to the LiDAR point cloud image. In this case, a voxel refers to a 3D pixel in the shape of a cube, and voxel down-sampling is a technology that reduces the number of points so as not to require excessive AI calculations while maintaining the structure of various objects included in a LiDAR point cloud.

Meanwhile, the LiDAR 120 emits, for example, m laser beams n times during one scan cycle, and in this case, the scan values of the laser beams that return after colliding with an external object constitute an (m x n) matrix, and (m x n) matrix data is called a range image. Each point that constitutes a LiDAR point cloud image includes depth (i.e., range) information, as well as the intensity, azimuth, inclination, and other additional information of the returned laser pulse. For a range image, AI learning is possible with large datasets such as Waymo^{TM} open dataset (WOD).

Range view (RV) is a technique that converts a 3D point cloud into a 2D or 2.5D scene, and expresses it as a LiDAR 3D map that humans intuitively understand, like an analog picture, instead of a large number of points. In a range view image, a 3D LiDAR point cloud image has 2D coordinates, but the 3D laser-related information (angle, inclination, intensity, etc.) recorded when obtaining the range image is not discarded. By applying a variable called a width to (x, y) coordinates among the (x, y, z) coordinate values of a 3D LiDAR image, the coordinate of one 2D axis is obtained, and by applying a variable called a height and range image information representing the range (depth) to the (z) coordinate, the coordinate of another 2D axis is obtained, which creates a 2D range view image.

In addition, an AI algorithm according to the present disclosure may include a convolutional neural network (CNN), which is an AI training module frequently used to extract features (or feature points) from image data. To this end, there are commercially available datasets including tens of thousands of images, and currently, there are CNN versions capable of processing images from one dimension to three dimensions. That is, the results of the range view image processing tool are used to train a CNN neural network and perform the function of helping AI accurately recognize objects in an image.

Because objects existing around an autonomous vehicle are ultimately recognized by a machine, an operation of generating a ground truth (GT) bounding box on the LiDAR map described above is also an important process in object recognition. In machine learning, ground truth (GT) is a term used to indicate an original or actual value of data that an AI is to learn. It may be understood as a type of image annotation applied to a LiDAR point cloud image, usually as a bounding box with a box-shaped boundary.

That is, in order to recognize objects, the AI module brings labels and groups various objects. The spacing of the 3D data points used to output the GT bounding box may be set to allow about 50 and 1000 LiDAR cloud points to be contained in one GT bounding box.

Such GT annotations do not exist in the raw data captured by sensors such as the LiDAR 120 and the like while the vehicle drives. The processor 110 recognizes objects belonging to various classes, such as road signs, crosswalks, pedestrians, other vehicles, and center lanes, as objects. GT annotation is a means used to measure an object recognition error and sometimes evaluate AI performance by comparing object determination results recognized by the AI algorithm of the processor 110 with reality. The GT bounding box, which is applied to the original image in the form of annotations, may be set manually by the user, but there are also commercially available GT calculation tools, such as Grid-striding.

Meanwhile, when driving the AI object recognition module, it is also possible to check the predicted bounding box. The result recognized by the processor 110 as an object of a specific class from the original image data obtained from the LiDAR sensor 120, and the like, appears in the form of another bounding box similar to the GT bounding box. Unlike GT bounding boxes, predicted bounding boxes are the result of computations by the autonomous driving AI. The predicted bounding box may coincide with the GT bounding box, but the predicted bounding box may not coincide with the GT bounding box or may not overlap with the GT bounding box at all.

For reference, because it is difficult to definitively determine that a specific class of object actually exists at a location based on predicted bounding boxes alone, the predicted bounding boxes are usually called probability boxes (P-Boxes).

Segmentation processing performed after preprocessing refers to, for example, displaying a specific part of a road (e.g., a traffic light) in red and the other parts (asphalt road) in blue. Clustering point clouds into specified groups and generating P-Boxes may also be performed at the segmentation operation. For reference, there is also a technology called cluster expansion, where the expansion target includes the cluster to all points within the epsilon distance (the minimum distance that constitutes the cluster) and the seed point.

Clustering and P-box generation based on a point cloud are performed during segmentation processing. In short, an AI network performing segmentation is used to obtain point labels from the LiDAR sensor 120.

In order to solve the problem of ground recognition errors occurring during segmentation, the present disclosure proposes a “rule-based” road surface recognition and label fusion technique. Such a road surface recognition algorithm may apply any of a variety of techniques, including slope-based road surface recognition, grid-based road surface recognition, and other non-planar-based road surface recognition. However, the present disclosure proposes to adopt a slope-based road surface recognition technique when recognizing the road surface inside a tunnel.

For reference, semantic segmentation is the task of attaching (e.g., applying) a unique class label to each point in the point cloud generated by the LiDAR 120. In LiDAR image processing technology, semantic segmentation is a technology that finds and uses meaningful information from LiDAR data for object recognition and scene reproduction required for implementing autonomous driving. Various semantic segmentation AI models already exist, such as a projection-based method, a point-based method, a sparse convolution-based method, and the like. For example, the semantic segmentation result may be the result of an AI operation performed by the processor 110 with the NVIDIA DRIVE™ AGX system, and through such a configuration, for example, various colors may be added to a LiDAR point cloud image.

After the segmentation process as above, LiDAR images are treated through a process called post-processing. The post-processing refers to converting point cloud data into 3D maps or modeling, which are meaningful information for autonomous driving. The post-processing also includes the process of finally removing noise and errors from LiDAR point cloud images, recognizing objects such as vehicles or pedestrians from the point cloud, and, if necessary, attaching (e.g., applying) a unique identifier to the point cloud information to register it.

FIG. 2 is a flowchart illustrating an example algorithm 200 for an object recognition architecture utilizing LiDAR segmentation.

Referring to FIG. 2, first, in operation S100, preprocessing is performed as described above. That is, the main input from the autonomous driving sensor 120 is preprocessed and the original data of a point cloud or vehicle network is processed into a form required by each software or hardware module of the architecture according to the present disclosure in operation S100.

In operation S110, object detection is performed. Operation S110 is performed by a recognition network that executes a detection task that recognizes the location, shape, and class of stereotyped shapes such as vehicles, pedestrians, pillars, and the like.

In operation S120, multi-class segmentation is performed. Operation S120 is performed by a segmentation task network that recognizes classes in units of point or grid for objects and surrounding environments that exist in a unique ratio, whether standardized or not.

In operation S130, ground recognition is performed, and a rule-based algorithm or a supplementary network for recognizing road surface-related classes in units of point or grid is executed in operation S130.

In operation S140, segment fusion is performed, and a rule-based algorithm or a supplementary ensemble network is performed to fuse the road surface-related class prediction results in units of point or grid to derive the final result.

In operation S150, instantiation or noise filtering is performed. Operation S150 is a process of filtering out noise while performing instantiation to perform information analysis in units of instance based on the class prediction results in units of point or grid.

In this case, instantiation may include window search and clustering processes. In addition, the noise filtering process may be performed before or after instantiation, or may be performed simultaneously with instantiation. Points or grids identified as noise may not be subject to analysis in subsequent modules, but in some cases, they may be utilized as additional features for extracting information in units of frame. For example, a noise point or grid may be utilized when predicting weather information for a specific frame.

In operation S160 of FIG. 2, an object cuboid box may be generated. That is, a rule-based algorithm or supplementary network that generates a cuboid box based on a point included in an instance may be executed in operation S160.

In operation S170, the outline of the object is extracted. A rule-based algorithm or supplementary network that expresses the outer shape of the instance by generating a shape containing multiple edges or vertices is executed in operation S170.

Operation S180 may be a process for object fusion. This may be a module that fuses detection, cuboid box, and contour data, which are information about an object. For regular objects, the object detection network output is mainly used, and for irregular objects, it is difficult to detect with the object detection network, so the remaining boxes among the object cuboid box outputs that are not associated with the object detection network output are mainly used. Not all objects are in the shape of a 3D cuboid box, and even for objects such as vehicles that are in the shape of a 3D cuboid box, it may be difficult to accurately estimate the shape using only a 3D cuboid box when considering a partial shape abnormality such as a side mirror and a state change such as a door being opened. Therefore, in operation S180, the most accurate shape inference result may be obtained by expressing the outer surface of an object through the object outline.

In operation S190, an occupancy model may be executed, and a rule-based algorithm or supplementary network that predicts the occupied area in the surrounding environment is executed. It is possible to simply output only the occupied area in a grid form, or use the output of the segmentation network to predict class information and dynamic flow by grid. A free space module, which represents only the drivable area in a more simplified form, may be included in operation S190.

In operation S200, a road model may be executed and a rule-based algorithm or supplementary network that predicts lanes, road boundaries and road surface geometry is executed.

In operation S210, the scene understanding model may be executed. A rule-based algorithm or supplementary network is executed to understand the current frame in a desired form based on a class prediction result in units of point or grid. For example, it is possible to predict the weather of the current frame, detect anomalies in the frame to predict contamination of sensor information, and derive various scene understanding results such as predicting the current situation and whether it is drivable.

In operation S220, feature point extraction may be performed. This is a feature extraction in units of point that satisfies desired conditions, so that it is possible to improve the performance by utilizing class information, or extract feature points that could not be extracted previously. As an example, extracting edge points of a static object may be illustrated, in which case class information may be required.

In operation S230, odometry data may be obtained. That is, when only static objects may be utilized when calculating the movement amount, it may greatly contribute to improving performance, and because class information may be utilized in this case, performance may be further improved. The output of operation S230 may be used as the main input for a mapping algorithm for map construction in addition to determination or control of autonomous driving.

The online calibration of operation S240 may be a module that may correct misalignment of an autonomous driving sensor during driving based on a continuous odometry estimation result.

Operation S250 may be an object measurement refinement/processing operation. This is a module that combines and processes measurement values required for object tracking. In object tracking, the results of the object fusion module in operation S180 are mainly utilized. However, the object fusion results may be precisely measured and processed by using an occupancy model (OM), a road model (RM), a scene understanding model, and odometry as inputs. Therefore, such processes are performed in operation S250.

Operation S260 is a measurement refinement/processing operation regarding the surrounding environment. This is a module that combines and processes measurement results required for tracking. In tracking the surrounding environment, the calculation results of the occupancy model (OM), road model (RM), and scene understanding model are mainly used, but this can be processed into more sophisticated measurement values in operation S260 by using object fusion and odometry as input.

Operation S270 performs tracking and post-processing on object information. By utilizing continuous frame information, the final output results are processed into the desired form, while stable compensation is possible, and results for various autonomous driving determination/control and mapping processes are provided.

In operation S280, tracking and post-processing for the surrounding environment information are performed. Like operation S270, by utilizing continuous frame information, the final output results are processed into the desired form, while stable compensation is possible, and results for various autonomous driving determination/control and mapping processes are provided.

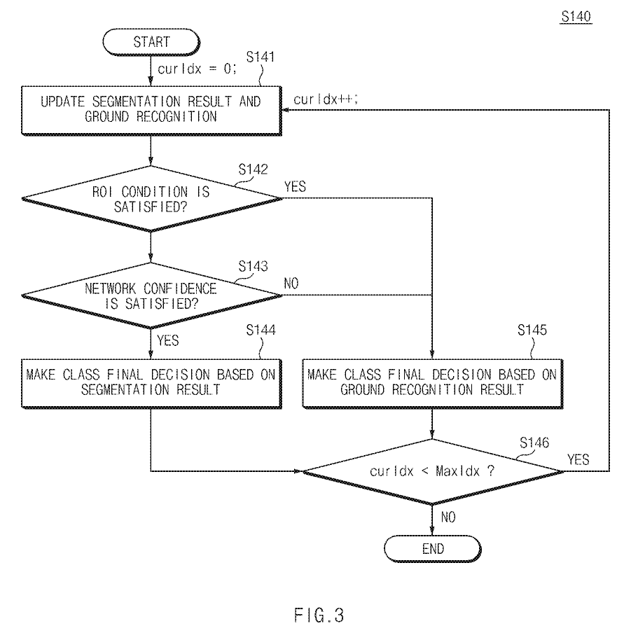

FIG. 3 is a flowchart illustrating an example algorithm regarding a segment fusion process of an object recognition architecture utilizing LiDAR segmentation. That is, FIG. 3 illustrates operation S140 of FIG. 2 in detail.

In operation S141, the segmentation result (operation S120) and the result of ground recognition (operation S130) are updated. Then, in operation S142, it is checked whether the region of interest (ROI) condition is satisfied. For example, the reference may be whether the object currently being analyzed is within a short distance of 5 m from the autonomous driving sensor 120.

When the ROI condition is not satisfied as the determination result in operation S141, the process moves to operation S143 to determine whether the network confidence score satisfies a specified threshold (e.g., whether the confidence is 0.9 or higher). The confidence of a network may be implemented by the score output by the network or by a combination of the score and an empirically implemented numerical value.

When the determination result in operation S143 is YES, the process moves to operation S144 and make a final decision on the class based on the segmentation result. When the result is YES in operation S142 or NO in operation S143, the process moves to operation S145 to make a final decision on the class based on the ground recognition result. In operation S146, the operations above described are repeated until the class cursor index curIdx value becomes equal to the MaxIdx value.

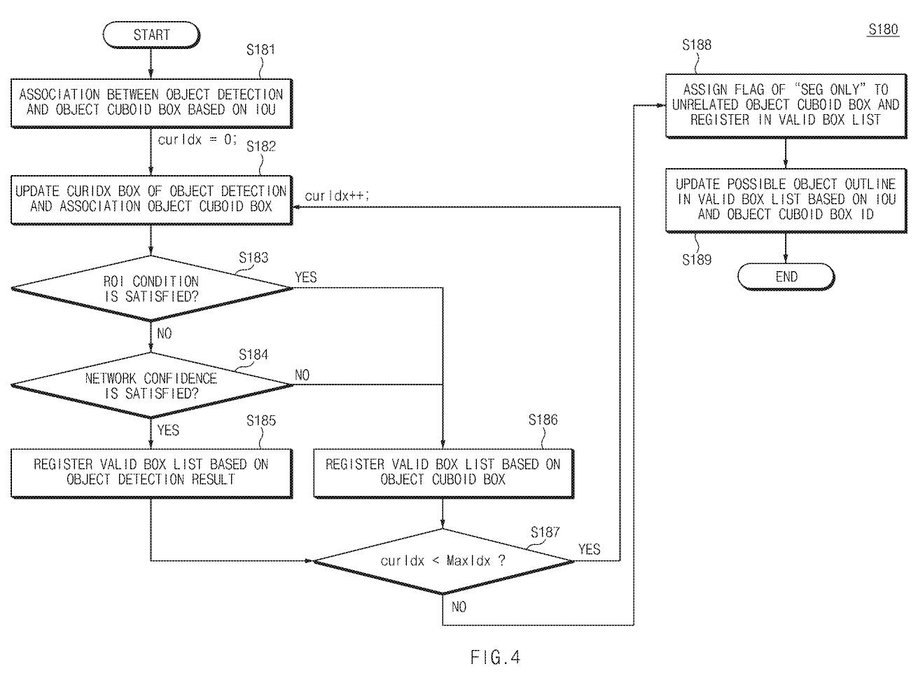

FIG. 4 is a flowchart illustrating an example algorithm regarding an object fusion process of an object recognition architecture utilizing LiDAR segmentation. That is, FIG. 4 illustrates operation S180 in FIG. 2 in detail.

In operation S181, an association operation is performed between the object detection result and the object cuboid box based on intersection over union (IoU).

In operation S182, the curIdx box of the object detection and the object cuboid box associated with the corresponding box are updated.

In operation S183, it is checked whether the ROI condition is satisfied. For example, whether an object exists within a field of view (FOV) boundary may be a determination reference.

For example, when it is determined in operation S183 that an object is not within the FOV boundary, the process moves to operation S184 to determine whether the network confidence satisfies a preset threshold (e.g., exceeds 0.6).

When the network confidence is satisfied in operation S184, the process moves to operation S185 and a valid box list is registered based on the object detection result. When the network confidence is not satisfied in operation S184 or the ROI condition is satisfied in operation S183, the process moves to operation S186 and a valid box list is registered based on the object cuboid box result.

Then, the above-described operations are repeated through operation S187 until the class cursor index curIdx value becomes equal to the MaxIdx value.

Then, in operation S188, a flag of “SEG ONLY” is assigned to an unrelated object cuboid box and registered in the valid box list, and in operation S189, possible object outline data is updated in the valid box list based on the IoU and the object cuboid box ID. For reference, the flag of “SEG ONLY” is a flag for tracking an irregular object that the detection network is difficult to detect based on segmentation.

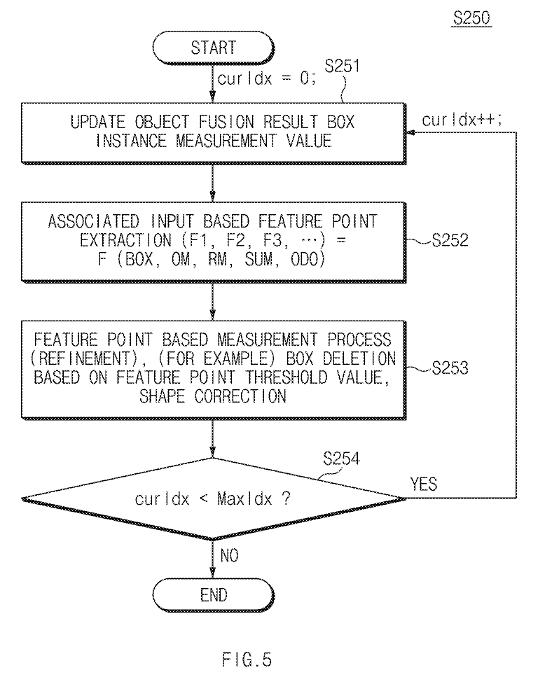

FIG. 5 is a flowchart illustrating an example algorithm for an object measurement refinement (or processing) process of an object recognition architectures utilizing LiDAR segmentation. That is, FIG. 5 illustrates operation S250 of FIG. 2.

Referring to FIG. 5, in operation S251, the object fusion result box instance measurement value is updated, and in operation S252, feature points (f1, f2, f3, …) are extracted based on the associated input. This may be a function that includes a box, an occupancy model (OM), a road model (RM), a scene understanding model (SUM), and odometry (ODO).

In operation S253, measurements are refined/processed based on feature points. For example, when the threshold value of a specific feature point is unsatisfactory, a box is deleted or a shape is corrected based on a specific feature point value. In operation S254, the above-described operations are repeated until the class cursor index curIdx value becomes equal to the MaxIdx value.

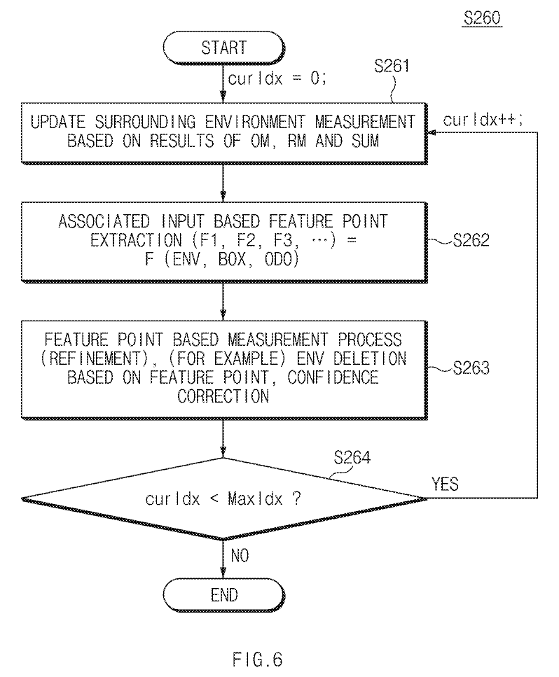

FIG. 6 is a flowchart illustrating an example algorithm for a refinement (or processing) process related to the surrounding environment measurement of an object recognition architecture utilizing LiDAR segmentation. That is, FIG. 6 illustrates operation S260 of FIG. 2 in detail.

Referring to FIG. 6, in operation S261, measurements for surrounding environment data are updated based on the results of the occupancy model (OM), road model (RM), and scene understanding model (SUM). In operation S262, feature points (f1, f2, f3, …) are extracted based on the associated input. This may be a function that includes measurements (ENV) of the surrounding environment, boxes (BOX), and odometry (ODO).

In operation S263, measurements are refined/processed based on feature points. For example, when the threshold of a specific feature point is unsatisfactory, ENV is deleted or ENV confidence is corrected based on a specific feature point value. In operation S264, the above-described operations are repeated until the class cursor index curIdx value becomes equal to the MaxIdx value.

The present disclosure proposes a system and a method capable of improving technology for recognizing an object, a surrounding environment, and calculation of a movement amount of host vehicles (equipped with autonomous driving sensors) by utilizing LiDAR segmentation.

That is, according to the present disclosure, it is configured to generate a recognition valid output for object/environment/host vehicle movement amount based on a logic architecture based on point class information by identifying the main unit logic module and the relationship between modules that is able to utilize the point unit class information, which is the result of the segmentation task. Furthermore, by utilizing the point unit class information resulting from the segmentation task, it is expected to improve the recognition performance to be robust to various noises and to deal with over/under segmentation phenomena.

In addition, according to the present disclosure, because classification is applied from the clustering operation, which is the first instantiation process in LiDAR recognition, in the shape analysis operation, which is the logic of the subsequent operation, a shape analysis algorithm such as an adaptive box search or a contour algorithm may be applied for each class, thereby even improving the shape analysis performance. In addition to other shape analysis modules, it may also be possible to configure unit architectures using point class information in various logic modules.

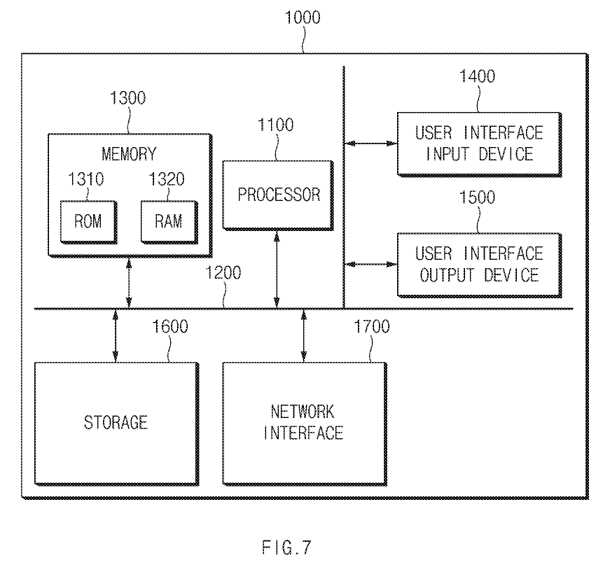

FIG. 7 is a block diagram illustrating an example computing system 1000 for controlling an autonomous vehicle and operating object recognition.

Referring to FIG. 7, the computing system 1000 may include at least one processor 1100, a memory 1300, a user interface input device 1400, a user interface output device 1500, storage 1600, and a network interface 1700 connected through a bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the processes of the method or algorithm described in relation to the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM.

The example storage medium may be coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to one aspect of the present disclosure, a system for recognizing an object by using segmentation of an autonomous driving sensor includes a processor that is provided with an object recognition module that recognizes the object existing in a surrounding environment from a plurality of point data input from the autonomous driving sensor, and a memory that stores the plurality of point data input, wherein the object recognition module performs detecting the object based on the plurality of point data, performing multi-class segmentation, and recognizing a point corresponding to a ground, first fusing a result of the multi-class segmentation and a result of recognizing the ground, second fusing a cuboid box for the object and an outline of the object, extracting a feature point and odometry for the surrounding environment based on a result of the first fusing, and executing object tracking based on a result of the second fusing and tracking for the surrounding environment based on the feature point and the odometry.

The second fusing of the cuboid box for the object and the outline of the object may include a process of combining and processing a result of fusing the cuboid box and the outline of the object.

The extracting of the feature point and the odometry may include a process of combining and processing results of measuring the surrounding environment and the odometry.

The combining and processing process may be performed based on at least one of an occupancy model, a road model, a scene understanding model, and the odometry.

The combining and processing process may be performed based on at least one of an occupancy model, a road model, a scene understanding model, and the odometry.

The object recognition module may further perform correcting a misalignment of the autonomous driving sensor during driving based on a result of continuously estimating the odometry.

The first fusing of the recognition results may include a process of determining a final class based on the result of recognizing the ground when an ROI condition is satisfied or a network confidence condition is not satisfied, and otherwise determining the final class based on the result of the multi-class segmentation.

The second fusing of the cuboid box for the object and the outline of the object may include a process of registering the cuboid box in a valid box list when an ROI condition is satisfied or a network confidence condition is not satisfied, and otherwise registering the object detection result in the valid box list.

The second fusing of the cuboid box for the object and the outline of the object may include a process of associating the object detection result with the cuboid box based on intersection over union (IoU) before determining the ROI condition.

The second fusing of the cuboid box for the object and the outline of the object may include a process of attaching a specific flag to an irregular object after registering the irregular object for which object detection is difficult in the valid box list, and tracking the object based on the segmentation, which is the result of the first fusing.

According to another aspect of the present disclosure, a method of recognizing an object and a surrounding environment by using a plurality of point data input from an autonomous driving sensor includes detecting, by an object recognition module, the object based on the plurality of point data, performing multi-class segmentation, and recognizing a point corresponding to a ground, first fusing, by the object recognition module, a result of the multi-class segmentation and a result of recognizing the ground, second fusing, by the object recognition module, a cuboid box for the object and an outline of the object, extracting, by the object recognition module, a feature point and odometry for the surrounding environment based on a result of the first fusing, and executing, by the object recognition module, object tracking based on a result of the second fusing and tracking for the surrounding environment based on the feature point and the odometry.

According to the present disclosure, there are provided a system and a method capable of improving recognition technology for an object, a surrounding environment and calculation on the movement amount of a vehicle (a vehicle equipped with an autonomous driving sensor) by utilizing LiDAR segmentation.

That is, according to the present disclosure, it is configured to generate a recognition valid output for object/environment/host vehicle movement amount based on a logic architecture based on point class information by identifying the main unit logic module and the relationship between modules that is able to utilize the point unit class information, which is the result of the segmentation task. Furthermore, by utilizing the point unit class information resulting from the segmentation task, it is expected to improve the recognition performance to be robust to various noises and to deal with over/under segmentation phenomena.

In addition, according to the present disclosure, because classification is applied from the clustering operation, which is the first instantiation process in LiDAR recognition, in the shape analysis operation, which is the logic of the subsequent operation, a shape analysis algorithm such as an adaptive box search or a contour algorithm may be applied for each class, thereby even improving the shape analysis performance. In addition to other shape analysis modules, it may also be possible to configure unit architectures using point class information in various logic modules.

In addition, through the detailed description of the present disclosure and the attached drawings, those skilled in the art will be able to understand various effects other than the effects described above from the present disclosure.

Although one or more example embodiments of the present disclosure have been described for illustrative purposes, those skilled in the art will appreciate that various modifications, additions, and substitutions are possible, without departing from the scope and spirit of the disclosure.

Therefore, the example embodiment(s) disclosed in the present disclosure are provided for the sake of descriptions, not limiting the technical concepts of the present disclosure, and it should be understood that such example embodiment(s) are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus of a vehicle, the apparatus comprising:
a processor; and
a memory storing at least one instruction that is configured, when executed by the processor, to cause the apparatus to:
receive, from a sensor of the vehicle, a plurality of point data corresponding to an object in a surrounding environment of the vehicle;
store, in the memory, the plurality of point data;
detect, based on the plurality of point data, the object;
perform multi-class segmentation on the plurality of point data;
recognize, based on the plurality of point data, a point that corresponds to a ground;
perform a first fusing operation on a result of the multi-class segmentation and a result of recognizing the point that corresponds to the ground;
perform a second fusing operation on a cuboid box for the object and an outline of the object;
extract, based on a result of the first fusing operation, a feature point and odometry for the surrounding environment;
track, based on a result of the second fusing operation, the object;
track, based on the feature point and the odometry, the surrounding environment; and
control, based on the tracking of the object and the tracking of the surrounding environment, an autonomous driving operation of the vehicle.

2. The apparatus of claim 1, wherein the at least one instruction is configured, when executed by the processor, to cause the apparatus to perform the second fusing operation by:
combining and processing a result of fusing the cuboid box and the outline of the object.

3. The apparatus of claim 2, wherein the at least one instruction is configured, when executed by the processor, to cause the apparatus to combine and process the result of fusing the cuboid box and the outline of the object based on at least one of: an occupancy model, a road model, a scene understanding model, or the odometry.

4. The apparatus of claim 1, wherein the at least one instruction is configured, when executed by the processor, to cause the apparatus to extract the feature point and the odometry by:
combining and processing results of measuring the surrounding environment and the odometry.

5. The apparatus of claim 4, wherein the at least one instruction is configured, when executed by the processor, to cause the apparatus to combine and process the results of measuring the surrounding environment and the odometry based on at least one of: an occupancy model, a road model, a scene understanding model, or the odometry.

6. The apparatus of claim 1, wherein the at least one instruction is configured, when executed by the processor, to further cause the apparatus to:
correct, during driving of the vehicle and based on a result of continuously estimating the odometry, a misalignment of the sensor.

7. The apparatus of claim 1, wherein the at least one instruction is configured, when executed by the processor, to cause the apparatus to perform the first fusing operation by:
determining a final class based on:
the result of recognizing the point that corresponds to the ground, based on a region of interest condition being satisfied or a network confidence condition not being satisfied; or
the result of the multi-class segmentation, based on the region of interest condition not being satisfied and the network confidence condition being satisfied.

8. The apparatus of claim 1, wherein the at least one instruction is configured, when executed by the processor, to cause the apparatus to perform the second fusing operation by one of:
registering the cuboid box in a valid box list based on a region of interest condition being satisfied or a network confidence condition not being satisfied, or
registering the object detection result in the valid box list based on the region of interest condition not being satisfied and the network confidence condition being satisfied.

9. The apparatus of claim 8, wherein the at least one instruction is configured, when executed by the processor with the memory, to cause the apparatus to perform the second fusing operation further by:
before determining the region of interest condition, associating a result of the detecting of the object with the cuboid box based on an intersection over union of the result of the detecting of the object and the cuboid box.

10. The apparatus of claim 8, wherein the at least one instruction is configured, when executed by the processor with the memory, to cause the apparatus to perform the second fusing operation by:
based on determining that the object has an irregular shape, tagging the object and registering the object in the valid box list, and
wherein the at least one instruction is configured, when executed by the processor with the memory, to cause the apparatus to track the object further based on the multi-class segmentation.

11. A method performed by an apparatus of a vehicle, the method comprising:
receiving, from a sensor of the vehicle, a plurality of point data corresponding to an object in a surrounding environment of the vehicle;
detecting, based on the plurality of point data, the object;
performing multi-class segmentation on the plurality of point data;
recognizing, based on the plurality of point data, a point that corresponds to a ground;
performing a first fusing operation on a result of the multi-class segmentation and a result of recognizing the point that corresponds to the ground;
performing a second fusing operation on a cuboid box for the object and an outline of the object;
extracting, based on a result of the first fusing operation, a feature point and odometry for the surrounding environment;
tracking, based on a result of the second fusing operation, the object;
tracking, based on the feature point and the odometry, the surrounding environment; and
controlling, based on the tracking of the object and the tracking of the surrounding environment, an autonomous driving operation of the vehicle.

12. The method of claim 11, wherein the second fusing operation comprises:
combining and processing a result of fusing the cuboid box and the outline of the object.

13. The method of claim 12, wherein the combining and processing process is based on at least one of: an occupancy model, a road model, a scene understanding model, or the odometry.

14. The method of claim 11, wherein the extracting of the feature point and the odometry comprises:
combining and processing results of measuring the surrounding environment and the odometry.

15. The method of claim 14, wherein the combining and processing is based on at least one of: an occupancy model, a road model, a scene understanding model, or the odometry.

16. The method of claim 11, further comprising:
correcting, during driving of the vehicle and based on a result of continuously estimating the odometry, a misalignment of the sensor.

17. The method of claim 11, wherein the first fusing operation comprises:
determining a final class based on:
the result of recognizing the point that corresponds to the ground, based on a region of interest condition being satisfied or a network confidence condition not being satisfied; or
the result of the multi-class segmentation, based on the region of interest condition not being satisfied and the network confidence condition being satisfied.

18. The method of claim 11, wherein the second fusing operation comprises:
registering the cuboid box in a valid box list based on a region of interest condition being satisfied or a network confidence condition not being satisfied, or
registering the object detection result in the valid box list based on the region of interest condition not being satisfied and the network confidence condition being satisfied.

19. The method of claim 18, wherein the second fusing operation comprises:
before determining the region of interest condition, associating a result of the detecting of the object with the cuboid box based on an intersection over union of the result of the detecting of the object and the cuboid box.

20. The method of claim 18, wherein the second fusing operation comprises:
based on determining that the object has an irregular shape, tagging the object and registering the object in the valid box list, and
wherein the tracking of the object is further based on the multi-class segmentation.
